(19) United States
(12) Patent Application Publication
(10) Pub. No.: US 2009/0081463 A1
(43) Pub. Date: Mar. 26, 2009

(54) TINTED ARTICLE HAVING A HIGH REFRACTIVE INDEX

(75) Inventors: Vidhu J. Nagpal, Murrysville, PA (US); Robert D. Herold, Monroeville, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: PPG INDUSTRIES OHIO, INC., Cleveland, OH (US)

(21) Appl. No.: 11/859,017

(22) Filed: Sep. 21, 2007

(51) Int. Cl. B32B 33/00; B05D 1/36

(52) U.S. Cl. 428/409; 427/402

(57) ABSTRACT

Disclosed is a tinted article formed from a substrate having a refractive index of at least 1.57 comprising at least partially polymerized sulfur-containing polyurethane material and/or at least partially polymerized sulfur-containing polyurethaneurea material; an intermediate coating applied to at least a portion of the substrate; a tintable hardcoat applied to at least a portion of the intermediate coating; and tint applied to at least a portion of the tintable hardcoat. Methods for preparing the tinted articles also are provided.

### FIELD OF THE INVENTION

The present invention is directed to a tinted article and a method for its preparation. In particular, the invention is directed to tinted optical articles having a refractive index of at least 1.57.

A number of organic polymeric materials, for example plastics, have been developed as alternatives and replacements for glass in applications such as optical lenses, fiber optics, windows and automotive, nautical and aviation transparencies. These polymeric materials can provide advantages relative to glass, including, shatter resistance, lighter weight for a given application, ease of molding and ease of dying. However, it has been observed that tinting of lenses made from sulfur-containing polyurethane and/or sulfur-containing polyurethaneurea materials have often resulted in rapid uptake of dye leading to non-uniform tinting of the lenses.

Thus, there is a need in the art to develop a method of improving the tint uniformity of articles such as lenses made from sulfur-containing polyurethane and/or sulfur-containing polyurethaneurea materials. The present invention provides a method of reducing the rate of dye (or tint) uptake thus improving tint uniformity.

### SUMMARY OF THE INVENTION

The present invention is directed to a tinted article which comprises a substrate adapted to have a refractive index of at least 1.57 comprising an at least partially polymerized sulfur-containing polyurethane and/or sulfur-containing polyurethaneurea material; an intermediate coating applied to at least a portion of the substrate; a tintable hardcoat applied to at least a portion of the intermediate coating; and dye (or tint) at least partially applied to the tintable hardcoat.

Further provided is a method of preparing a tinted article which comprises a substrate adapted to have a refractive index of at least 1.57, i.e., having a refractive index of at least 1.57, said substrate comprising an at least partially polymerized sulfur-containing polyurethane material and/or an at least partially polyermized sulfur-containing polyurethaneurea material. The method comprises:
(a) applying an intermediate coating to at least a portion of at least one surface of the substrate;
(b) applying a tintable hardcoat to at least a portion of the intermediate coating; and
(c) applying a tint to at least a portion of the tintable hardcoat.

### DETAILED DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are each understood to be non-limiting with respect to the scope of the invention. As previously mentioned the present invention is directed to a tinted article which comprises a substrate having a refractive index of at least 1.57 comprising an at least partially polymerized sulfur-containing polyurethane and/or at least partially polymerized sulfur-containing polyurethaneurea material; an intermediate coating applied to at least a portion of the substrate; a tintable hardcoat applied to at least a portion of the intermediate coating; and dye (or tint) at least partially applied to the tintable hardcoat.

As previously mentioned, the substrate used to prepare the tinted article of the present invention comprises a sulfur-containing polyurethane and/or sulfur-containing polyurethaneurea materials. Suitable substrate materials can include, but are not limited to, sulfur-containing polyurethane, sulfur containing polyurethaneurea, polythiocarbamate, polythiocarbamateurea, polythiourethane, polythiourethaneurea, polydithiourethane, polydithiourethaneurea, and/or copolymers thereof. Mixtures of any of the aforementioned polymers may be used.

Polyurethane refers to polymeric materials containing urethane (—NR—C(O)—O—) linkages. Polyurethaneurea refers to polymeric materials containing urethane linkages and urea (—NR—C(O)—NR—) linkages. Polythiocarbamate refers to polymeric materials containing thiocarbamate (—NR—C(S)—O—) linkages. Polythiocarbamateurea refers to polymeric materials containing thiocarbamate and urea linkages. Polythiourethane refers to polymeric materials containing thiourethane (—NR—C(O)—S—) linkages. Polythiourethaneurea refers to polymeric materials containing thiourethane and urea linkages. Polydithiourethane refers to polymeric materials containing dithiourethane (—NR—C(S)—S—) linkages. Polydithiourethaneurea refers to polymeric materials containing dithiourethane and urea linkages as previously mentioned, where R is hydrogen or alkyl.

Suitable sulfur-containing polyurethane and/or sulfur-containing polyurethaneurea materials for use in the present invention can be selected from any of those known to one skilled in the art.

The sulfur-containing polyurethane and/or sulfur-containing polyurethaneurea material of the present invention can be prepared by reacting: (a) polyisocyanate and/or polyisothiocyanate-containing material comprising polyisocyanate, polyisothiocyanate, sulfur-containing polyisocyanate, sulfur-containing polyisothiocyanate or combinations thereof; (b) a first active hydrogen-containing material; and (c) a second active hydrogen-containing material different from (b).

The first active hydrogen-containing material can comprise a hydroxyl group-containing compound and/or an amino group-containing compound. The first active hydrogen-containing material also can comprise sulfur-containing active hydrogen-containing materials, such as SH-containing compounds. In a particular embodiment the first active hydrogen-containing material can comprise a hydroxyl group, an amino group and/or an SH group or can comprise a compound having at least one sulfur linkabe group other than SH and at least one active hydrogen-containing group, such as a hydroxyl group, an SH group, and/or an amino group.

The second active hydrogen material which can function as a curing agent which is different from the first active hydrogen-containing material can comprise a compound having at least two active hydrogen groups, such as hydroxyl groups, SH groups, and/or amino groups Alternatively, the second active hydrogen material can comprise a compound having at least one sulfur linkage other than SH, and at least two active hydrogen-containing groups, such as hydroxyl groups, SH groups, and/or amino groups.

The polyisocyanate and polyisothiocyanate materials useful in the present invention can be blocked or unblocked and capable of forming a covalent bond with active hydrogen-containing materials such as a thiol, hydroxyl, or amine functional group-containing materials. The polyisocyanate typically contains at least two isocyanate (NCO) functional groups and the polyisothiocyanate typically contains at least two isothiocyanate (NCS) functional groups. The sulfur-containing polyisocyanate can contain one or more sulfur atoms. The sulfur-containing polyisothiocyanate can contain one or more sulfur atoms in addition to the isothiocyanate groups.

The sulfur-containing polyurethane and/or sulfur-containing polyurethaneurea materials suitable for use in the present invention can result in a polymerizate having a refractive index of at least 1.57, or at least 1.58, or at least 1.59, or at least 1.60, or at least 1.65. Also, the sulfur-containing polyurethane and/or sulfur-containing polyurethaneurea material can result in a polymerizate (i.e., substrate) having an Abbe number of at least 28, such as at least 30, or at least 32, or at least 35, or at least 36, or at least 38, or at least 39, or at least 40, or at least 42, or at least 44. The Abbe number can range between any of the recited values inclusive of those recited values.

The refractive index and Abbe number can be determined by methods known in the art, such as ASTM Number D 542-00, using various known instruments. For example, the refractive index and Abbe number can be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8.1. An Atago, model DR-M2 Multi-Wavelength Digital Abbe Refractometer can be used to measure the refractive index and Abbe number of the samples/specimens.

Further, the sulfur-containing polyurethane and/or sulfur-containing polyurethaneurea materials of the present invention when cured can have low density. For example, the density can range from greater than 0.9 to less than 1.5 grams/cm³, such as from greater than 1.0 to less than 1.45 grams/cm³, or from greater than 1.0 to less than 1.3 grams/cm³.

In one non-limiting embodiment, the sulfur-containing polyurethane and/or sulfur-containing polyurethaneurea materials of the present invention can be prepared by first preparing a prepolymer comprising the reaction product of polyisocyanate-containing material and the first active hydrogen-containing material and reacting said prepolymer with the second active hydrogen-containing material which is different than the first.

The amount of polyisocyanate(s) and/or polyisothiocyanate(s), and the amount of active hydrogen-containing material(s) in the prepolymer can be selected such that the equivalent ratio of (NCO+NCS):(SH+OH) can be greater than 1.0:1.0, such as at least 2.0:1.0, or at least 2.5:1. Also the amount of polyisocyanate(s) and/or polyisothiocyanate(s) can be selected such that the equivalent ratio of (NCO+NCS):(SH+OH) can be less than 4.5:1.0, or less than 5.5:1.0, or less than 6.5:1.0. Further, the equivalent ratio of (NCO+NCS):(SH+OH+NR), wherein R is hydrogen or alkyl, can be greater than 1.0:1.0, such as at least 2.0:1.0, or at least 2.5:1. Also the equivalent ratio of (NCO+NCS):(SH+OH+NR) where R is hydrogen or alkyl, can be less than 4.5:1.0, or less than 5.5:1.0, or less than 6.5:1.0.

In another non-limiting embodiment, the prepolymer can be prepared by reacting polyisocyanate and/or polyisothiocyanate with an active hydroxyl-containing material such as a polyol or polythiol. Also, the NCO to OH equivalent ratio for the prepolymer can range from 2.0 to less than 5.5, e.g. from 2.1 to 5.4 or from any range of numbers in between.

Polyisocyanates and polyisothiocyanates useful in the preparation of the sulfur-containing polyurethane and/or sulfur-containing polyurethaneurea of the present invention are numerous and widely varied. Suitable polyisocyanates and polyisothiocyanates for use in the present invention can include but are not limited to polymeric and C₂-C₂₀ linear, branched, cyclic and aromatic polyisocyanates and polyisothiocyanates. Non-limiting examples can include polyisocyanates and polyisothiocyanates having backbone linkages chosen from urethane linkages (—NH—C(O)—O—), thiourethane linkages (—NH—C(O)—S—), thiocarbamate linkages (—NH—C(S)—O—), dithiourethane linkages (—NH—C(S)—S—) and combinations thereof. The molecular weight of the polyisocyanate and polyisothiocyanate can vary widely.

Non-limiting examples of suitable polyisocyanates and polyisothiocyanates can include but are not limited to polyisocyanates having at least two isocyanate groups; isothiocyanates having at least two isothiocyanate groups; mixtures thereof; and combinations thereof, including a material having both NCO and NCS functionalities.

Non-limiting examples of polyisocyanates can include but are not limited to aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanato groups are attached directly to the aromatic ring, and aromatic polyisocyanates wherein one or more of the isocyanato groups are not attached directly to the aromatic ring. In some instances when an aromatic polyisocyanate is used, generally care should be taken to select a material that does not cause the poly(urea)urethane to develop an undesirable color (e.g., yellow).

The polyisocyanate can include, for example, aliphatic or cycloaliphatic diisocyanates and/or aromatic diisocyanates, cyclic dimmers and cyclic trimers thereof, and mixtures thereof. Non-limiting examples of suitable polyisocyanates can include but are not limited to DESMODUR N 3300 (hexamethylene diisocyanate trimer), DESMODUR N 3400 (60% hexamethylene diisocyanate dimer and 40% hexamethylene diisocyanate trimer) both commercially available from Bayer.

Also, the polyisocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

By way of example, three suitable isomers of 4,4′-methylenebis(cyclohexyl isocyanate) are shown below.

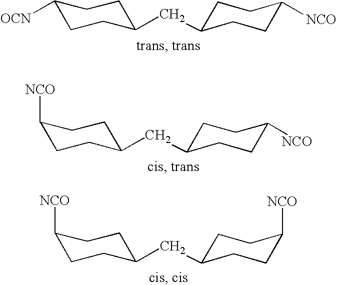

Additional aliphatic and cycloaliphatic diisocyanates can include 3-isocyanato-methyl-3,5,5-trimethyl cyclohexyl-isocyanate (“IPDI”) and meta-tetramethylxylene diisocyanate (1,3-bis(1-isocyanato-1-methylethyl)-benzene).

As used herein and the claims, the terms aliphatic and cycloaliphatic diisocyanates refer to compounds having 6 to 100 carbon atoms linked in a straight chain or cyclized, having two reactive isocyanate end groups. The aliphatic and cycloaliphatic diisocyanates for use in the present invention can include TMXDI and compounds of the formula R—(NCO)₂ wherein R represents an aliphatic group or a cycloaliphatic group.

Further non-limiting examples of suitable polyisocyanates and polyisothiocyanates can include but are not limited to aliphatic polyisocyanates and polyisothiocyanates; ethylenically unsaturated polyisocyanates and polyisothiocyanates; alicyclic polyisocyanates and polyisothiocyanates; aromatic polyisocyanates and polyisothiocyanates wherein the isocyanate groups are not bonded directly to the aromatic ring, e.g., α,α′-xylene diisocyanate; aromatic polyisocyanates and polyisothiocyanates wherein the isocyanate groups are bonded directly to the aromatic ring, e.g., benzene diisocyanate.

Examples of the sulfur-containing polyisocyanates and sulfur-containing polyisothiocyanates include aliphatic polyisocyanates and polyisothiocyanates containing sulfide linkages; aromatic polyisocyanates and polyisothiocyanates containing sulfide or disulfide linkages; aromatic polyisocyanates and polyisothiocyanates containing sulfone linkages; sulfonic ester-type polyisocyanates and polyisothiocyanates, e.g., 4-methyl-3-isocyanatobenzenesulfonyl-4′-isocyanato-phenol ester; aromatic sulfonic amide-type polyisocyanates and polyisothiocyanates; sulfur-containing heterocyclic polyisocyanates and polyisothiocyanates, e.g., thiophene-2,5-diisocyanate.

The aforementioned polyisocyanate-containing materials include halogenated, alkylated, alkoxylated, nitrated, carbodiimide modified, urea modified and biuret modified derivatives of the polyisocyanates, polyisothiocyanates, sulfur-containing polyisocyanates and sulfur-containing polyisothiocyanates thereof; and dimerized and trimerized products thereof.

The sulfur-containing polyurethane and/or the sulfur-containing polyurethaneurea may be prepared by reacting all the components simultaneously (i.e., a “one stage” method) or by first reacting the polyisocyanate and/or the polyisothiocyanate with the first active hydrogen material to form a pre-polymer, then reacting the prepolymer with the second active hydrogen material (i.e., a “two stage” method).

Further, a sulfur-containing polyisocyanate of the following general formula (I) can be used in preparation of the polyurethane prepolymer:

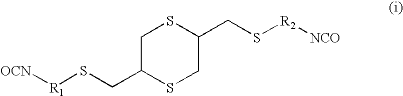

wherein R₁ and R₂ are each independently C₁ to C₃ alkyl.

Further non-limiting examples of aliphatic polyisocyanates can include ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Examples of ethylenically unsaturated polyisocyanates can include but are not limited to butene diisocyanate and 1,3-butadiene-1,4-diisocyanate. Alicyclic polyisocyanates can include but are not limited to isophorone diisocyanate, cyclohexane diisocyanate, methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]-heptane.

Examples of aromatic polyisocyanates wherein the isocyanate groups are not bonded directly to the aromatic ring can include but are not limited to bis(isocyanatoethyl)benzene, α,α,α′,α′-tetramethylxylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl)phthalate, mesitylene triisocyanate and 2,5-di(isocyanatomethyl)furan. Aromatic polyisocyanates having isocyanate groups bonded directly to the aromatic ring can include but are not limited to phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, ortho-toluidine diisocyanate, ortho-tolylidine diisocyanate, ortho-tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4-methyldiphenylmethane-3,5,2′,4′,6′-pentaisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate and dichlorocarbazole diisocyanate.

Further non-limiting examples of aliphatic and cycloaliphatic diisocyanates that can be used in the present invention include 3-isocyanato-methyl-3,5,5-trimethyl cyclohexyl-isocyanate (“IPDI”) which is commercially available from Arco Chemical, and meta-tetramethylxylene diisocyanate (1,3-bis(1-isocyanato-1-methylethyl)-benzene) which is commercially available from Cytec Industries Inc. under the tradename TMXDI.RTM. (Meta)Aliphatic Isocyanate.

In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group.

Non-limiting examples of sulfur-containing polyisocyanates can include aliphatic polyisocyanates containing sulfide linkages such as thiodiethyl diisocyanate, thiodipropyl diisocyanate, dithiodihexyl diisocyanate, dimethylsulfone diisocyanate, dithiodimethyl diisocyanate, dithiodiethyl diisocyanate, dithiodipropyl diisocyanate and dicyclohexylsulfide-4,4′-diisocyanate. Non-limiting examples of aromatic sulfur-containing polyisocyanates containing sulfide or disulfide linkages include but are not limited to diphenylsulfide-2,4′-diisocyanate, diphenylsulfide-4,4′-diisocyanate, 3,3′-dimethoxy-4,4′-diisocyanatodibenzyl thioether, bis(4-isocyanatomethylbenzene)-sulfide, diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5′-diisocyanate, 3,3′-dimethoxydiphenyldisulfide-4,4′-diisocyanate and 4,4′-dimethoxydiphenyldisulfide-3,3′-diisocyanate.

Non-limiting examples sulfur-containing polyisocyanates can include aromatic polyisocyanates containing sulfone linkages such as diphenylsulfone-4,4′-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyl-diphenylsulfone-3,3′-diisocyanate and 4,4′-dichlorodiphenylsulfone-3,3′-diisocyanate.

Non-limiting examples of aromatic sulfonic amide-type sulfur-containing polyisocyanates for use in the present invention can include 4-methyl-3-isocyanato-benzene-sulfonylanilide-3′-methyl-4′-isocyanate, dibenzenesulfonyl-ethylenediamine-4,4′-diisocyanate, 4,4′-methoxybenzenesulfonyl-ethylenediamine-3,3′-diisocyanate and 4-methyl-3-isocyanato-benzene-sulfonylanilide-4-ethyl-3′-isocyanate.

In alternate non-limiting embodiments, the polyisothiocyanate can include aliphatic polyisothiocyanates; alicyclic polyisothiocyanates, such as but not limited to cyclohexane diisothiocyanates; aromatic polyisothiocyanates wherein the isothiocyanate groups are not bonded directly to the aromatic ring, such as but not limited to α,α′-xylene diisothiocyanate; aromatic polyisothiocyanates wherein the isothiocyanate groups are bonded directly to the aromatic ring, such as but not limited to phenylene diisothiocyanate; heterocyclic polyisothiocyanates, such as but not limited to 2,4,6-triisothicyanato-1,3,5-triazine and thiophene-2,5-diisothiocyanate; carbonyl polyisothiocyanates; aliphatic sulfur-containing polyisothiocyanates containing sulfide linkages, such as but not limited to thiobis(3-isothiocyanatopropane); aromatic sulfur-containing polyisothiocyanates containing sulfur atoms in addition to those of the isothiocyanate groups; halogenated, alkylated, alkoxylated, nitrated, carbodiimide modified, urea modified and biuret modified derivatives of these polyisothiocyanates; and dimerized and trimerized products of these polyisothiocyanates.

Non-limiting examples of aliphatic polyisothiocyanates include 1,2-diisothiocyanatoethane, 1,3-diisothiocyanatopropane, 1,4-diisothiocyanatobutane and 1,6-diisothiocyanatohexane. Non-limiting examples of aromatic polyisothiocyanates having isothiocyanate groups bonded directly to the aromatic ring can include but are not limited to 1,2-diisothiocyanatobenzene, 1,3-diisothiocyanatobenzene, 1,4-diisothiocyanatobenzene, 2,4-diisothiocyanatotoluene, 2,5-diisothiocyanato-m-xylene, 4,4′-diisothiocyanato-1,1′-biphenyl, 1,1′-methylenebis(4-isothiocyanatobenzene), 1,1′-methylenebis(4-isothiocyanato-2-methylbenzene), 1,1′-methylenebis(4-isothiocyanato-3-methylbenzene), 1,1′-(1,2-ethane-diyl)bis(4-isothiocyanatobenzene), 4,4′-diisothiocyanatobenzophenenone, 4,4′-diisothiocyanato-3,3′-dimethylbenzophenone, benzanilide-3,4′-diisothiocyanate, diphenylether-4,4′-diisothiocyanate and diphenylamine-4,4′-diisothiocyanate.

Suitable carbonyl polyisothiocyanates can include but are not limited to hexane-dioyl diisothiocyanate, nonanedioyl diisothiocyanate, carbonic diisothiocyanate, 1,3-benzenedicarbonyl diisothiocyanate, 1,4-benzenedicarbonyl diisothiocyanate and (2,2′-bipyridine)-4,4′-dicarbonyl diisothiocyanate. Non-limiting examples of aromatic polyisothiocyanates containing sulfur atoms in addition to those of the isothiocyanate groups, can include but are not limited to 1-isothiocyanato-4-[(2-isothiocyanato)sulfonyl]benzene, thiobis(4-isothiocyanatobenzene), sulfonylbis(4-isothiocyanatobenzene), sulfinylbis(4-isothiocyanatobenzene), dithiobis(4-isothiocyanatobenzene), 4-isothiocyanato-1-[(4-isothiocyanatophenyl)-sulfonyl]-2-methoxybenzene, 4-methyl-3-isothicyanatobenzene-sulfonyl-4′-isothiocyanate phenyl ester and 4-methyl-3-isothiocyanatobenzene-sulfonylanilide-3′-methyl-4′-isothiocyanate.

Non-limiting examples of materials having isocyanate and isothiocyanate groups can include aliphatic, alicyclic, aromatic, heterocyclic, or contain sulfur atoms in addition to those of the isothiocyanate groups. Non-limiting examples of such materials can include but are not limited to 1-isocyanato-3-isothiocyanatopropane, 1-isocyanato-5-isothiocyanatopentane, 1-isocyanato-6-isothiocyanatohexane, isocyanatocarbonyl isothiocyanate, 1-isocyanato-4-isothiocyanatocyclohexane, 1-isocyanato-4-isothiocyanatobenzene, 4-methyl-3-isocyanato-1-isothiocyanatobenzene, 2-isocyanato-4,6-diisothiocyanato-1,3,5-triazine, 4-isocyanato-4′-isothiocyanato-diphenyl sulfide and 2-isocyanato-2′-isothiocyanatodiethyl disulfide.

As discussed above, the polyisocyanate and/or polyisothiocyanate material can be reacted with an active hydrogen-containing material comprising a hydroxyl-containing material to form a polyurethane prepolymer. Hydroxyl-containing materials are varied and known in the art. Non-limiting examples can include but are not limited to polyols; sulfur-containing materials such as but not limited to hydroxyl functional polysulfides, and SH-containing materials such as but not limited to polythiols; and materials having both hydroxyl and thiol functional groups. Numerous examples of such materials are described in U.S. patent application Ser. No. 11/360,011 filed on Feb. 22, 2006 in paragraphs [0044] to [0144] which disclosure is incorporated herein by reference.

Suitable hydroxyl-containing materials also can include, but are not limited to, polyether polyols, polyester polyols, polycaprolactone polyols, and/or polycarbonate polyols. Mixtures of any of the previously mentioned hydroxyl-containing materials can be used.

Polyether polyols and methods for their preparation are known to one skilled in the art. Non-limiting examples of polyether polyols can include polyoxyalkylene polyols, polyalkoxylated polyols and POLYMEG™ polyols reported to be polytetramethylene ether polyols. Polyoxyalkylene polyols can be prepared in accordance with known methods. In a non-limiting embodiment, a polyoxyalkylene polyol can be prepared by condensing an alkylene oxide, or a mixture of alkylene oxides, using acid- or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation. Non-limiting examples of such polyoxyalkylene polyols include polyoxyethylene, and polyoxypropylene, such as but not limited to polypropylene glycol.

In a non-limiting embodiment, polyalkoxylated polyols can be represent by the following general formula (I′):

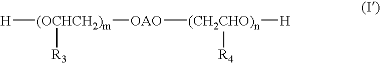

wherein m and n can each be a positive integer, the sum of m and n being from 5 to 70; R₃ and R₄ are each hydrogen, methyl or ethyl; and A is a divalent linking group such as a straight or branched chain alkylene which can contain from 1 to 8 carbon atoms, phenylene, and C₁ to C₉ alkyl-substituted phenylene. The chosen values of m and n can, in combination with the chosen divalent linking group, determine the molecular weight of the polyol. Polyalkoxylated polyols can be prepared by methods that are known in the art. In a non-limiting embodiment, a polyol such as 4,4′-isopropylidenediphenol can be reacted with an oxirane-containing material such as but not limited to ethylene oxide, propylene oxide and butylene oxide, to form what is commonly referred to as an ethoxylated, propoxylated or butoxylated polyol having hydroxy functionality. Non-limiting examples of polyols suitable for use in preparing polyalkoxylate polyols can include those polyols described in U.S. Pat. No. 6,187,444 B1 at column 10, lines 1-20, which disclosure is incorporated herein by reference.

As used herein and the claims, the term “polyether polyols” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. Also included are the polyethers prepared by the copolymerization of cyclic ethers such as but not limited to ethylene oxide, propylene oxide, trimethylene oxide, and tetrahydrofuran with aliphatic diols such as but not limited to ethylene alcohol, 1,3-butanediol, 1,4-butanediol, dihydroxydiethyl ether, 2,2′-dihydroxydopropyl ether, 1,2-propand diol and 1,3-propane diol. Compatible mixtures of polyether polyols can also be used. As used herein, “compatible” means that the polyols are mutually soluble in each other so as to form a single phase.

A variety of condensation polyester polyols for use in the present invention are known in the art. Suitable polyester polyols can include but are not limited to polyester diols. Polyester diols for use in the present invention can include the esterification products of one or more dicarboxylic acids having from four to ten carbon atoms, such as but not limited to adipic, succinic or sebacic acids, with one or more low molecular weight diols having from two to ten carbon atoms, such as but not limited to 1,2-ethanediol, 1,2-propanediol, dihydroxydiethyl ether, 1,4-butanediol, 2,2-dimethyl 1,3-propanediol, 1,6-hexanediol and 1,10-decanediol. Esterification procedures for producing polyester diols is described, for example, in the article D. M. Young, F. Hostettler et al., “Polyesters from Lactone,” Union Carbide F-40, p. 147.

In a non-limiting embodiment, the polyol for use in the present invention can include polycaprolactone polyols. Suitable polycaprolactone polyols are varied and known in the art. In a non-limiting embodiment, polycaprolactone polyols can be prepared by ring opening polymerization of caprolactone in the presence of difunctional active hydrogen compounds such as but not limited to water or low molecular weight polyols as recited herein. Non-limiting examples of suitable polycaprolactone polyols can include commercially available materials designated as the CAPA series from Solvay Chemical which includes but is not limited to CAPA 2047A, reported to be polycaprolactone polyester diol and the TONE series from Dow Chemical such as but not limited to TONE 0201, reported to be a linear polycaprolactone diol.

Polycarbonate polyols for use in the present invention are varied and known to one skilled in the art. Suitable polycarbonate polyols can include those commercially available (such as but not limited to Ravecarb™ 107 from Enichem S.p.A.). The polycarbonate polyol can be produced by reacting an organic diol, described hereinafter and in connection with the diol component of the polyureaurethane, and a dialkyl carbonate, such as described in U.S. Pat. No. 4,160,853. The polyol can include polyhexamethyl carbonate such as HO—(CH₂)₆-[O—C(O)—O—(CH₂)₆]ₓ—OH, wherein x is an integer from 4 to 24, or from 4 to 10, or from 5 to 7.

The polyol material can comprise low molecular weight polyols such as polyols having a number average molecular weight of less than 500 grams/mole, and compatible mixtures thereof. As used herein, “compatible” means that the polyols are mutually soluble in each other so as to form a single phase. Non-limiting examples of these polyols can include but are not limited to low molecular weight diols and triols. In some instances the amount of triol should be chosen so as to avoid a high degree of cross-linking in the polyurethane. The organic diol typically contains from 2 to 16, or from 2 to 6, or from 2 to 10, carbon atoms. Further non-limiting examples of such polyols can include but are not limited to triethylene glycol, tetraethylene glycol, 2,2′-dihydroxydopropyl ether, tripropylene glycol, 1,2-, 1,3- and 1,4-butanediol, 2,2,4-trimethyl-1,3-pentanediol, 2-methyl-1,3-pentanediol, 1,3-2,4- and 1,5-pentanediol, 2,5- and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, glycerin and isomers thereof.

In alternate non-limiting embodiments, the hydroxyl-containing material can have a molecular weight of at least 200 grams/mole, or at least 1000 grams/mole, or at least 2000 grams/mole. In alternate non-limiting embodiments, the hydroxyl-containing material can have a number average molecular weight of less than 10,000 grams/mole, or less than 15,000 grams/mole, or less than 20,000 grams/mole, or less than 32,000 grams/mole.

Polyols such as Pluronic R, Pluronic L62D, Tetronic R and Tetronic, which are commercially available from BASF, can be used as the active hydrogen-containing material in the present invention.

Non-limiting examples of suitable polyols for use in the present invention also can include straight or branched chain alkane polyols, such as b u t not limited to 1,2-ethanediol, 1,3-propanediol, 1,2-propanediol, trimethylolethane,ethoxylated trimethylolpropane, trimethylolpropane, di-trimethylolpropane, erythritol, pentaerythritol and di-pentaerythritol; polyoxyalkylene polyols, such as but not limited to dihydroxydiethyl ether and higher polyoxyalkylene polyols such as but not limited to polyoxyethylene polyols which can have number average molecular weights of from 200 grams/mole to 2,000 grams/mole; cyclic alkane polyols, such as but not limited to cyclopentanediol, cyclohexanediol, e.g., 1,4-cyclohexanediol, cyclohexanetriol, cyclohexanedimethanol, e.g., 1,4-cyclohexanedimethanol, hydroxypropylcyclohexanol, 1,2-bis(hydroxyethyl)cyclohexane and cyclohexanediethanol; aromatic polyols, such as but not limited to dihydroxybenzene, benzenetriol, hydroxybenzyl alcohol and dihydroxytoluene; bisphenols, such as, 4,4′-isopropylidenediphenol; 4,4′-oxybisphenol, 4,4′-dihydroxybenzophenone, 4,4′-thiobisphenol, phenolphthlalein, bis(4-hydroxyphenyl)methane, 4,4′-(1,2-ethenediyl)bisphenol and 4,4′-sulfonylbisphenol; halogenated bisphenols, such as but not limited to 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as but not limited to alkoxylated 4,4′-isopropylidenediphenol which can have from 1 to 70 alkoxy groups, for example, ethoxy, propoxy, α-butoxy and β-butoxy groups; and biscyclohexanols, which can be prepared by hydrogenating the corresponding bisphenols, such as but not limited to 4,4′-isopropylidene-biscyclohexanol, 4,4′-oxybiscyclohexanol, 4,4′-thiobiscyclohexanol and bis(4-hydroxycyclohexanol)methane; polyurethane polyols, polyester polyols, polyether polyols, poly vinyl alcohols, polymers having hydroxy functional groups such as polymers having hydroxy functional (meth)acrylates, e.g, acrylates and methacrylates, and polymers having allyl alcohols and isomers thereof.

Also, the polyol can comprise a polyurethane prepolymer having two or more hydroxy functional groups. Such polyurethane prepolymers can be prepared from any of the above-listed polyols and aforementioned polyisocyanates. The OH:NCO equivalent ratio can be chosen such that essentially no free NCO groups are produced in preparing the polyurethane prepolymer. The equivalent ratio of OH to NCO (i.e., isocyanate) present in the polyether-containing polyurethane prepolymer can range from 2.0 to less than 5.5.

The sulfur-containing active hydrogen materials suitable for use in the present invention can include a SH-containing material such as but not limited to a polythiol having at least two thiol groups. Non-limiting examples of suitable polythiols can include but are not limited to aliphatic polythiols, cycloaliphatic polythiols, aromatic polythiols, heterocyclic polythiols, and/or polymeric polythiols. Such materials can have linkages including but not limited to ether linkages (—O—), sulfide linkages (—S—), polysulfide linkages (—Sₓ—, wherein x is at least 2, or from 2 to 4) and combinations of such linkages. As used herein and the claims, the terms “thiol,” “thiol group,” “mercapto” or “mercapto group” refer to an —SH group which is capable of forming a thiourethane linkage, (i.e., —NH—C(O)—S—) with an isocyanate group or a dithioruethane linkage (i.e., —NH—C(S)—S—) with an isothiocyanate group.

Non-limiting examples of suitable polythiols can include but are not limited to 2,5-dimercaptomethyl-1,4-dithiane, dimercaptoethylsulfide, pentaerythritol tetrakis(3-mercaptopropionate), pentaerythritol tetrakis(2-mercaptoacetate), trimethylolpropane tris(3-mercaptopropionate), trimethylol propane tris(2-mercaptoacetate), 4-mercaptomethyl-3,6-dithia-1,8-octanedithiol, 4-tert-butyl-1,2-benzenedithiol, 4,4′-thiodibenzenethiol, ethanedithiol, benzenedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), and mixtures thereof.

The polythiol can be chosen from materials represented by the following general formula (II),

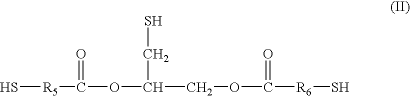

wherein R₅ and R₆ are each independently straight or branched chain alkylene, cyclic alkylene, phenylene and/or C₁-C₉ alkyl substituted phenylene. Non-limiting examples of straight or branched chain alkylene can include but are not limited to methylene, ethylene, 1,3-propylene, 1,2-propylene, 1,4-butylene, 1,2-butylene, pentylene, hexylene, heptylene, octylene, nonylene, decylene, undecylene, octadecylene and/or icosylene. Non-limiting examples of cyclic alkylenes can include but are not limited to cyclopentylene, cyclohexylene, cycloheptylene, cyclooctylene, and alkyl-substituted derivatives thereof. The divalent linking groups R₅ and R₆ can be phenylene and/or alkyl-substituted phenylene, such as methyl, ethyl, propyl, isopropyl and nonyl substituted phenylene. In a particular embodiment, R₅ and R₆ are each methylene or ethylene.

Further, the polythiol represented by general formula (II) can comprise thioglycerol bis(2-mercaptoacetate). As used herein and the claims, the term “thioglycerol bis(2-mercaptoacetate)” refers to any related co-product oligomeric species and polythiol monomer compositions containing residual starting materials. In a non-limiting embodiment, oxidative coupling of thiol groups can occur when washing the reaction mixture resulting from the esterification of 3-mercapto-1,2-propanediol and a thiol functional carboxylic acid, such as but not limited to 2-mercaptoacetic acid, with excess base, such as but not limited to aqueous ammonia. Such an oxidative coupling can result in the formation of oligomeric polythiol species having disulfide linkages, such as but not limited to —S—S— linkages.

Additional suitable polythiols can include but are not limited to polythiol oligomers having disulfide linkages, which can be prepared from the reaction of a polythiol having at least two thiol groups and sulfur in the presence of a basic catalyst. The equivalent ratio of polythiol monomer to sulfur can be from m to (m−1) wherein m represents an integer from 2 to 21. The polythiol can be chosen from any of the above-mentioned examples, such as but not limited to 2,5-dimercaptomethyl-1,4-dithiane.

Non-limiting examples of co-product oligomeric species can include materials represented by the following general formula (III):

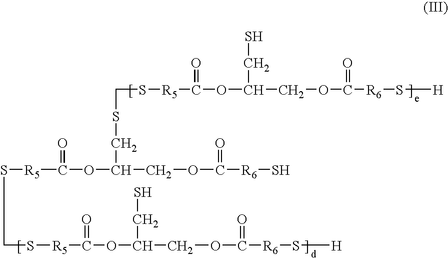

wherein R₅ and Rb can be as described above, e and d are each independently an integer from 0 to 21 provided (e+d) is at least 1.

In one non-limiting embodiment the active hydrogen-containing material (b) comprises polythiol comprising:
(a) thioether-functional, oligomeric polythiol having pendant hydroxyl functional groups, prepared by reacting together
   1. a compound having at least two thiol functional groups;
   2. a hydroxyl functional compound having triple bond functionality; and
   3. optionally a compound having at least two double bonds
(b) a polythiol comprising an oligomer which is the reaction product of at least two different dienes and at least one dithiol; and wherein the stoichiometric ratio of the sum of the number of equivalents of dithiol to the sum of the number of equivalents of diene is greater than 1.0:1.0; or
(c) combinations thereof.

The thioether-functional, oligomeric polythiol having pendant hydroxyl functional groups described above can be prepared by reacting at least one compound having at least two thiol functional groups, at least one hydroxyl functional compound having triple bond functionality and optionally at least one compound have double bond functionality. This process is further described in U.S. patent application Ser. No. 11/744,251 filed on May 4, 2007 in paragraphs [0028] to [0094] which disclosure is incorporated herein by reference.

A compound having at least two thiol groups that can be used to prepare the thioether-functional, oligomeric polythiol includes the polythiol oligomer having disulfile linkages represented by the following general formula (IV),

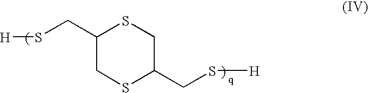

wherein q represents an integer from 1 to 21. The polythiol oligomer represented by general formula (IV) can be prepared, for example, by the reaction of 2,5-dimeracaptomethyl-1,4-dithiane with sulfur in the presence of a basic catalyst.

The polythiol can include at least one represented by the following structural formulas:

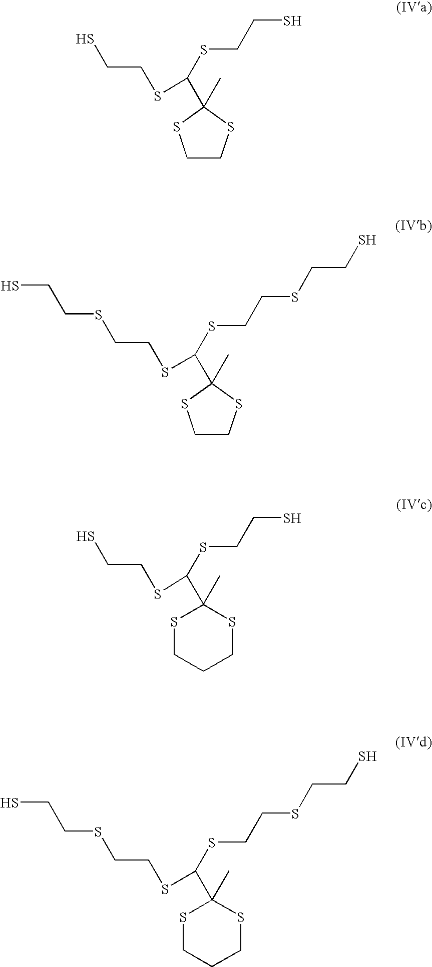

The sulfide-containing polythiols comprising 1,3-dithiolane (e.g., formulas IV'a and b) or 1,3-dithiane (e.g., formulas IV'c and d) can be prepared by reacting asym-dichloroacetone with polymercaptan, and then reacting the reaction product with polymercaptoalkylsulfide, polymercaptan or mixtures thereof using methods known in the art.

The aforementioned polythiol comprising an oligomer which is the reaction product of at least two different dienes and at least one dithiol that can be used to prepare the thioether-functional, oligomeric polythiol is described in U.S. patent application Ser. No. 11/360,011 filed on Feb. 22, 2006 in paragraphs [00145] to [00200] which disclosure is incorporated herein by reference.

Additionally, the active hydrogen-containing material suitable for use in the present invention can comprise polyether polyols and polyester polyols having a number average molecular weight of at least 200 grams/mole, or at least 300 grams/mole, or at least 750 grams/mole; or no greater than 1,500 grams/mole, or no greater than 2,500 grams/mole, or no greater than 4,000 grams/mole.

Non-limiting examples of suitable materials having both hydroxyl and thiol groups can include but are not limited to 2-mercaptoethanol, 3-mercapto-1,2-propanediol, glycerin bis(2-mercaptoacetate), glycerin bis(3-mercaptopropionate), 1-hydroxy-4-mercaptocyclohexane, 2,4-dimercaptophenol, 2-mercaptohydroquinone, 4-mercaptophenol, 1,3-dimercapto-2-propanol, 2,3-dimercapto-1-propanol, 1,2-dimercapto-1,3-butanediol, trimethylolpropane bis(2-mercaptoacetate), trimethylolpropane bis(3-mercaptopropionate), pentaerythritol mono(2-mercaptoacetate), pentaerythritol bis(2-mercaptoacetate), pentaerythritol tris(2-mercaptoacetate), pentaerythritol mono(3-mercaptopropionate), pentaerythritol bis(3-mercaptopropionate), pentaerythritol tris(3-mercaptopropionate), hydroxymethyl-tris(mercaptoethylthiomethyl)methane, 1-hydroxyethylthio-3-mercaptoethylthiobenzene, 4-hydroxy-4′-mercaptodiphenylsulfone, dihydroxyethyl sulfide mono(3-mercaptopropionate and hydroxyethylthiomethyl-tris(mercaptoethylthio)methane.

The polyisocyanate and/or polyisothiocyanate and the first active hydrogen-containing material can be reacted to form the prepolymer (e.g., a polyurethane or polyurethaneurea prepolymer), and the prepolymer then can be reacted with the second active hydrogen material (e.g., an amine-containing curing agent). Alternatively, the polyisocyanate and/or polyisothiocyanate, the first active hydrogen-containing material and the second active hydrogen material, can be reacted together in a “one pot” process.

Amine-containing materials for use in the present invention are numerous and widely varied. Non-limiting examples of suitable amine-containing materials can include but are not limited to aliphatic polyamines, cycloaliphatic polyamines, aromatic polyamines, and mixtures thereof. Also, the amine-containing material can be a polyamine having at least two functional groups independently chosen from primary amine (—NH₂), secondary amine (—NH—) and combinations thereof. The amine-containing material can have at least two primary amine groups. Moreover, the amine-containing material can further comprise polythiol and/or polyol. Non-limiting examples of suitable polythiols and polyols include those described previously. The amine-containing material can be a sulfur-containing amine-containing material. A non-limiting example of a sulfur-containing amine-containing material can include Ethacure 300 which is commercially available from Albemarle Corporation.

Suitable amine-containing curing agents for use in the present invention can include but are not limited to materials having the following chemical formula (V):

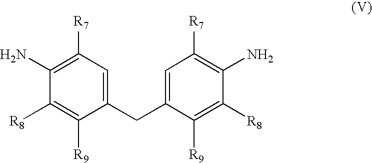

wherein R₇ and R₈ are each independently methyl, ethyl, propyl, or isopropyl groups, and R₉ is hydrogen or chlorine. Non-limiting examples of amine-containing curing agents for use in the present invention can include the following compounds, manufactured by Lonza Ltd. (Basel, Switzerland):

LONZACURE.RTM. M-DIPA: R₇═C₃H₇; R₈═C₃H₇; R₉═H

LONZACURE.RTM. M-DMA: R₇═CH₃; R₈═CH₃; R₉═H

LONZACURE.RTM. M-MEA: R₇═CH₃; R₈═C₂H₅; R₉═H

LONZACURE.RTM. M-DEA: R₇═C₂H₅; R₈═C₂H₅; R₉═H

LONZACURE.RTM. M-MIPA: R₇═CH₃; R₈═C₃H₇; R═H

LONZACURE.RTM. M-CDEA: R₇═C₂H₅; R₈═C₂H₅; R₉═Cl

wherein R₇, R₈ and R₉ correspond to the aforementioned chemical formula.

Also, the amine-containing curing agent can comprise diamine curing agent such as 4,4′-methylenebis(3-chloro-2,6-diethylaniline), available as Lonzacure.RTM. M-CDEA, which is available from Air Products and Chemical, Inc. (Allentown, Pa.). The amine-containing curing agent also can include 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals under the trade name MOCA. DETDA can be a liquid at room temperature with a viscosity of 156 cPs at 25° C. DETDA can be isomeric, with the 2,4-isomer range being from 75 to 81 percent white the 2,6-isomer range can be from 18 to 24 percent.

It should be understood that the amine-containing curing agent can act as a catalyst in the polymerization reaction and can be incorporated into the resulting polymerizate.

Further non-limiting examples of the amine-containing curing agent can include ethyleneamines. Suitable ethyleneamines can include but are not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), and 2-amino-1-ethylpiperazine. In alternate non-limiting embodiments, the amine-containing curing agent can be chosen from one or more isomers of C₁-C₃ dialkyl toluenediamine, such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. In alternate non-limiting embodiments, the amine-containing curing agent can be methylene dianiline or trimethyleneglycol di(para-aminobenzoate).

In alternate non-limiting embodiments of the present invention, the amine-containing curing agent can include one of the general structures described in U.S. patent application Ser. No. 11/360,011 filed on Feb. 22, 2006 in paragraphs [00215] to [00218] which disclosure is incorporated herein by reference.

In a non-limiting embodiment, the sulfur-containing polyurethaneurea of the present invention can be polymerized using a variety of techniques known in the art. In one non-limiting embodiment, wherein the sulfur-containing polyurethaneurea can be prepared by introducing together a polyisocyanate and/or polyisothiocyanate containing material and a first active hydrogen-containing material (e.g. hydroxyl or a thiol-containing material such as a polythiol or a hydroxyl and polythiol containing material) to form a polyurethane prepolymer, and then introducing the second active hydrogen containing material which is different from the first active hydrogen-containing material (e.g. amine, thiol-and/or hydroxyl-containing materials, said sulfur-containing polyurethaneurea can be polymerized, for example, by degassing the prepolymer, and degassing the second active hydrogen-containing material, and mixing the degassed prepolymer and said amine-containing material together.

The sulfur-containing polyurethaneurea can be prepared by a one-pot process where the sulfur-containing polyurethaneurea can be polymerized by separately degassing under vacuum the polyisocyanate and/or polyisothiocyanate, the active hydrogen-containing material (e.g., polyol and/or polythiol), and the amine-containing material; and then mixing the components together.

The sulfur-containing polyurethane and/or sulfur-containing polyurethaneurea of the present invention can be used to prepare various articles including optical elements such as lenses, displays, screens, visors, windows, mirrors and the like. In the preparation of a lens, the degassed components can be mixed together and introduced into a mold and the mold can be heated using a variety of conventional techniques known in the art. The thermal cure cycle can vary depending on, for example, the reactivity and molar ratio of the reactants and the presence of catalyst(s). For example, the thermal cure cycle can include heating the prepolymer and curing agent mixture, or the polyisocyanate and/or polyisothiocyanate, the first active-hydrogen-containing material, and the second active hydrogen-containing material, from room temperature to 200° C. over a period of from 0.5 hours to 72 hours.

A urethane-forming catalyst can be used in the present invention to enhance the reaction of the polyurethane-forming materials. Suitable urethane-forming catalysts can vary, for example, suitable urethane-forming catalysts can include those catalysts that are useful for the formation of urethane by reaction of the NCO and active hydrogen-containing materials. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In non-limiting embodiments, the catalyst can be a stannous salt of an organic acid, such as but not limited to stannous octoate; dibutyl tin dilaurate; dibutyl tin diacetate; dibutyl tin mercaptide; dibutyl tin dimaleate; dimethyl tin diacetate; dimethyl tin dilaurate; and mixtures thereof. Further, the catalyst may comprise zinc octoate, bismuth and salts thereof, and/or ferric acetylacetonate.

Further non-limiting examples of suitable catalysts can include tertiary amines such as but not limited to triethylamine, triisopropylamine and N,N-dimethylbenzylamine. Such suitable tertiary amines are disclosed in U.S. Pat. No. 5,693,738 at column 10, lines 6-38, the cited disclosure of which is incorporated herein by reference. Suitable catalyst can include, for example, 1,4-diazabicyclo[2.2.2]octane,phosphines and/or tertiary ammonium salts.

Various known additives can be incorporated into the polyurethane and/or poly(urea)urethane materials. Such additives can include but are not limited to light stabilizers, heat stabilizers, antioxidants, ultraviolet light absorbers, mold release agents, static (non-photochromic) dyes, photochromic dyes, pigments and flexibilizing additives, such as but not limited to alkoxylated phenol benzoates and poly(alkylene glycol) dibenzoates. Non-limiting examples of anti-yellowing additives can include 3-methyl-2-butenol, organo pyrocarbonates and triphenyl phosphite (CAS registry no. 101-02-0), or triaryl phosphite.

The resulting sulfur-containing polyurethane and/or sulfur-containing polyurethaneurea when at least partially cured can be used to form a substrate that is solid, rigid, non-elastomeric and essentially transparent such that it is suitable for optical or ophthalmic applications having refractive indices of at least 1.57 and Abbe numbers suitable for such applications as previously mentioned.

Solid articles that can be prepared using the sulfur-containing polyurethane and/or sulfur-containing polyurethaneurea materials of the present invention can include but are not limited to those mentioned above, for example, optical lenses, such as piano and ophthalmic lenses, sun lenses, windows, display panels and screens, automotive transparencies, such as windshields, sidelights and backlights, aircraft transparencies and the like.

In the present invention, a tinted article can be prepared using a substrate which includes a sulfur-containing polyurethane and/or sulfur-containing polyurethaneurea material as described above. Once the substrate comprising the sulfur-containing polyurethane and/or sulfur-containing polyurethaneurea material is at least partially polymerized, an intermediate coating can be applied to at least a portion of the substrate. Then a tintable hardcoat can be applied to at least a portion of the intermediate coating. A tint (dye) solution then is applied over at least a portion of tintable hardcoat. The process of applying a intermediate coating followed by a tintable hardcoat and then applying a tint may be applied to lenses having a refractive index less than 1.57. The makeup of such lenses can vary widely and include polyurethane and poly(urea urethane) polymers, which are prepared, for example, by the reaction of a polyurethane prepolymer and a diamine curing agent, a composition for one such polymer being sold under the trademark TRIVEX by PPG Industries, Inc.

The intermediate coating can be at least partially applied to at least one surface of the substrate. The intermediate coating can function to reduce the rate and the amount of dye or tint absorbed by the substrate. It has been observed that reducing the rate of uptake of dye or tint by the substrate can result in a more uniformly tinted article. In the present invention, the rate of tint uptake of the lens with intermediate coating is slower than that of a similar lens with no intermediate coating applied thereto.

The intermediate coating can include a wide variety of coating materials known in the art. Non-limiting examples of suitable materials for use as the intermediate coating in the present invention can include but are not limited to CRYSTAL COAT™ TC-339 (commercially available from SDC Technologies Inc., Anaheim, Calif.) and Hi-Gard® 1080 (commercially available from PPG Industries, Inc.).

The intermediate coating can be applied using any of a wide variety of techniques known to the skilled artisan. Non-limiting examples can include but are not limited to spray coating, spin coating, spread coating, curtain coating, dip or immersion coating, casting or roll coating. The intermediate coating can be applied using varying amounts provided the amount of intermediate coating applied to at least a portion of the substrate is such that the rate of tint uptake of the lens with the intermediate coating is slower than that of the uncoated lens. The thickness of the cured intermediate coating which is applied onto at least one surface of the at least partially polymerized substrate can range from 0.5 to 30 microns, such as from 1 to 7 microns.

Following application of the intermediate coating to the substrate, the coated substrate can be dried. The drying process can be conducted using a variety of conventional techniques known in the art, including but not limited to air-drying. In general, the drying process is carried out at a temperature ranging from 15° C. to 100° C.; and the time period should be such that the coating becomes substantially tack-free. For example, the coated substrate can be air dried at a temperature ranging from 15° C. to 100° C. for a time ranging from 5 to 60 minutes; or at a temperature ranging from 20° C. to 65° C. for a period ranging from 15 to 35 minutes. The coated substrate can be dried and subsequently cured. The curing process can include various techniques known to one having ordinary skill in the art. Such techniques can include but are not limited to thermal curing, and/or radiation curing, e.g. as by actinic (UV) or ionizing (electron beam) radiation. The curing process will be dependent upon the coating components and the substrate itself, as well as recommendations of the coating manufacturer. In general, the temperature and time period selected for the curing process should be such that the rate of dye or tint uptake of the substrate with intermediate coating when immersed in a dye or tint bath for a period of from 1 to 30 minutes is slower than that of a substrate with no intermediate coating.

Generally, the temperature of the curing process can range from 80° to 180° C., or from 100° to 150° C., or from 110° to 130° C.; and the time period can range from 1 to 10 hours, such as from 3 to 5 hours.

In order to promote wetting adhesion of the subsequently applied tintable hardcoat, the substrate coated with the intermediate coating layer can be pretreated such as by etching. Etching can be conducted using a variety of techniques known to one of ordinary skill in the art. Such techniques can include but are not limited to immersing the article in caustic solution. For example, the article, e.g., a lens, can be immersed in a stainless steel etch bath (equipped with heating coils, a re-circulating temperature controller, and an ultrasonicator) containing sodium hydroxide (caustic) solution with a concentration of from 5 to 20% by weight. The article can be immersed in the etch bath for a period of from 30 seconds to 20 minutes, at a temperature of from 15° to 60° C., with ultrasonication, followed by rinsing with water and isopropyl alcohol, and drying. Other known adhesion promotion techniques may be employed, such as plasma or corona treatment.

The tintable hardcoat for use in the present invention can include any of those known to one having ordinary skill in the art. Non-limiting examples of suitable tintable hardcoats can include but are not limited to Hi-Gard® 1020 (commercially available from PPG Industries, Inc.), CrystalCoat™ TC-332 and CrystalCoat™ TC-3000 (commercially available from SDC Technologies Inc., Anaheim, Calif.), UV-NV (commercially available from Ultra Optics Company in Brooklyn Park, Minn.), TS-56T (commercially available from Tokoyama Soda Corporation), and those disclosed in U.S. Pat. No. 4,211,823, U.S. Pat. No. 4,525,421, and U.S. Pat. No. 5,221,560.

The tintable hardcoat can be applied using a wide variety of techniques known to the skilled artisan including those described above with reference to the intermediate coating layer.

The amount of tintable hardcoat employed can vary. The amount of tintable hardcoat applied to at least a portion of the intermediate coating layer is such that the desired amount of dye or tint is absorbed by the article when immersed in a tint or dye bath. The coating can be applied according to the coating conditions recommended by the coating manufacturer. The coating thickness of tintable hardcoat applied over at least a portion of the intermediate coating layer can range from 0.5 to 30 microns, such as from 1 to 10 microns.

The tintable hardcoat can be dried in accordance with the conditions recommended by the coating manufacturer, or conditions including, but not limited to, those described above relative to the intermediate coating.

The tintable hardcoat can be dried and then cured according to the conditions recommended by the coating manufacturer, or conditions including, but not limited to those provided above relative to the intermediate coating.

The tintable hard coat material employed, the amount of tintable hard coat applied, and the drying and curing conditions are chosen to achieve tint (or dye) uptake of at least 20% within 60 minutes or less, such as to achieve tint (or dye) uptake of at least 70% within 30 minutes or less, when immersed at a temperature of from 90° to 100° C. in a tint (or dye) bath comprising 1 part by weight of a commercially available disperse dye solution diluted with 9 parts by weight of water.

The substrate including the intermediate coating and the tintable hardcoat then can be tinted using a variety of tint/dyes, using methods for their application which are known to one of ordinary skill in the art. Such tints or dyes typically are aqueous solutions of disperse dyes such as BPI-Black and BPI-Brown (commercially available from Brainpower Inc. of Miami, Fla.) and AO-Brown (commercially available from Cerium Optical Products of Kent, England).

The tint (or dyes) can be applied to the tintable hardcoat using a variety of conventional techniques, including but not limited to immersing the coated article in an aqueous solution of dyes at elevated temperature. The tint (or dye) can be applied according to the following process: The tint solution is prepared by diluting 1 part by weight of commercially available solution of disperse dye with 9 parts by weight of water. The article to be tinted is completely immersed in the dye solution at a temperature of from 90° to 100° C., for a period of from 30 seconds to 120 minutes.

The amount of tint (or dye) and the ratio of substances (for example, when mixtures are used) should be such that the article to which the tint (or dye) is applied exhibits the desired resultant color, e.g., a substantially neutral color such as shades of gray or brown. Also, the amount of tint (or dye) used can depend upon the intensity of the color and the ultimate color desired.

In general, the more tint dye applied, the greater the color intensity.

The tinted articles of the present invention can include one tint (or dye) or a mixture of more than one. Various mixtures of tint (or dyes) can be used to attain colors such as a near neutral gray or brown.

Following the tinting process, the luminous transmittance of the tinted article can be measured using a variety of techniques known in the art, such as by using a spectrophotometer. For example, the luminous transmittance of the tinted article of the present invention can be measured using a Varian Cary 50 UV-Visible Spectrophotometer, using CIE illuminant C, an observer angle of 2°, and a wavelength range of from 400 to 700 nm, where the Tristimulus value Y is reported as % luminous transmittance. The luminous transmittance value can be used to determine the percent uptake of tint dye by the substrate according to the following formula: % Tint Uptake=[% Tᵢₙᵢₜᵢₐₗ−% T_{final})/% Tᵢₙᵢₜᵢₐₗ]×100%

wherein T represents luminous transmittance.

The surface of the substrate to be coated can be cleaned prior to application of the intermediate coating and/or tintable hardcoat. The cleaning of the substrate can promote adhesion of the intermediate coating. A variety of cleaning techniques are known in the art, including but not limited to cleaning with soap and water, followed by rinsing with water and isopropyl alcohol and air-drying.

As previously mentioned, etching can be performed for the purpose of improving the wetting and adhesion of subsequent coating applied on the surface of a previously-applied coating. In an embodiment, the tintable hardcoat can be etched as previously described herein, in relation to the intermediate coating.

The lens with intermediate coating applied thereto typically has less than 50% tint uptake within 30 minutes, when immersed in a dye (or tint) bath comprising 1 part by weight of a commercially available disperse dye solution diluted with 9 parts by weight of water, at a temperature of from 90 to 100° C., where percent dye (or tint) uptake is defined as follows:

% Tint (or dye) Uptake=[(% Tᵢₙᵢₜᵢₐₗ−% T_{final})/% Tᵢₙᵢₜᵢₐₗ]×100%, where T represents luminous transmittance, as measured with a spectrophotometer.

If desired, a protective or an abrasion-resistant coating can be applied to at least one surface of the tinted article. A variety of such coatings are known to one of ordinary skill in the art, and include those disclosed herein. In an embodiment, the abrasion-resistant coating for use in the present invention can be selected from sol gel based hard coating materials.

The present invention is more particularly described in the following examples, which are intended to be illustrative only, since numerous modifications and variations therein will be apparent to those skilled in the art. Unless otherwise specified, all parts and all percentages are by weight.

### EXAMPLE 1

### Step A

High Index lenses prepared according to Example 22 of U.S. application Ser. No. 11/744,251 filed May 4, 2007, which example is incorporated herein by reference, were cleaned with soap and water, rinsed with deionized water and isopropyl alcohol, and allowed to air-dry at ambient temperature (approximately 21-26° C.). An intermediate coating of Crystal Coat™ TC-339 obtained from SDC Technologies Inc., was applied to the lenses of Examples 1A and 1B at ambient temperature (e.g., from 21-26° C.) by dip coating according to the following procedure. The dip coating equipment consisted of a platform which was raised and lowered using a pneumatically powered motor, where the speed of the platform travel was regulated by appropriately adjusting the air pressure, until the desired speed was attained (measured by timing with a stopwatch the rate of platform travel in seconds/inch). The lens was held vertically with a stationary lens holder, the container holding the coating solution was placed on the platform, and the platform was raised to completely immerse the vertically suspended lens in the coating solution. The platform was then pneumatically lowered at the desired rate, in order to apply the coating on the lens. The speed at which the lens was extracted from the solution (referred to hereinafter as “extraction rate”) was 6 seconds/inch. The coated lenses were air-dried for 30 minutes at 30° C. in a forced-air oven and cured in a forced air oven at 127° C. for 4 hours.

### Step B

The coated lenses from Step A were immersed in an etch bath for 3 minutes into sodium hydroxide (caustic) solution (with a concentration of 12% by weight) maintained at 30° C. The etch bath consisting of a stainless steel vessel (equipped with heating coils, a re-circulating temperature controller, and an ultrasonicator), After etching the lenses were rinsed with water and isopropyl alcohol, and dried at approximately 30° C. in a forced air oven.

### Step C

After Step B, two different tintable hardcoats were applied to the lenses of Step B and another set of lenses that did not have an intermediate coating which served as a Comparative Example (CE). The tintable hardcoat CrystalCoat™ TC-332 was applied to the lenses of Example 1A and CE1A and CrystalCoat™ TC-3000 was applied to the lenses of Example 1B and CE 1B. The CrystalCoat™ tintable hardcoats were applied using a dip coating method as described above. The lenses dip coated with CrystalCoat™ TC-332 had an extraction rate of 6 seconds/inch, and those coated with CrystalCoat™ TC-3000 had an extraction rate of 10 seconds/inch. The lenses with CrystalCoat™ coatings were air dried for 30 minutes at 30° C. and cured at 127° C. for 4 hours.

### Step D

The lenses from Step C were then tinted in a tint bath which was prepared by mixing 1 part by weight of BPI Black concentrate (commercially obtained from Brain Power Inc. FLORIDA) with 9 parts by weight of de-ionized water. The tint bath was covered and the contents were thoroughly mixed and heated to and maintained at a temperature of from 92-97° C. Each lens was vertically mounted on a holder and immersed in the dye bath to completely submerge the lens. Each lens was held in the bath for 30 minutes. Each lens was removed from the bath, rinsed thoroughly with water, and wiped dry with a paper towel.

The percent tint uptake was measured according to the following procedure using the instrument HazeGuard from BYK and measured as follows:

% Tint Uptake=[% Tᵢₙᵢₜᵢₐₗ−% T_{final})/% Tᵢₙᵢₜᵢₐₗ]×100%

wherein T represents luminous transmittance.

% Tᵢₙᵢₜᵢₐₗ was representative of the light transmittance of a lens having no tint dye applied, and was typically approximately 91.5%.

The results demonstrated by Examples 1A & 1B and Comparative Examples 1A & 1B are recorded in Table 1 below.

In addition to measuring the rate of tint uptake, the tinted lenses were examined visually with the aid of a light box. It was observed that lenses having an intermediate coating were substantially more uniformly tinted than lenses that were tinted having no intermediate coating.

TABLE 1

| | | Intermediate | % Tint Uptake |
|---|---|---|---|
| Sample ID | Tintable Coating | coating | 30 min |
| 1A | CrystalCoatTM | CrystalCoatTM | 48 |
| | TC-332 | TC-339 | |
| CE1A | CrystalCoatTM | None | 89 |
| | TC-332 | | |
| 1B | CrystalCoatTM | CrystalCoatTM | 36 |
| | TC-3000 | TC-339 | |
| CE1B | CrystalCoatTM | None | 87 |
| | TC-3000 | | |

The invention has been described with reference to non-limiting embodiments. Obvious modifications and alterations can occur to others upon reading and understanding the detailed description. It is intended that the invention be construed as including all such modifications and alterations insofar as they come within the scope of the appended claims or the equivalents thereof.

We claim:

1. A tinted article comprising:
(a) substrate having a refractive index of at least 1.57 comprising an at least partially polymerized sulfur-containing polyurethane and/or at least partially polymerized sulfur-containing polyurethaneurea material;
(b) an intermediate coating applied to at least a portion of the substrate;
(c) a tintable hardcoat applied to at least a portion of the intermediate coating; and
(d) tint applied to at least a portion of the tintable hard coat.

2. The tinted article of claim 1 wherein said sulfur-containing polyurethane and/or sulfur-containing polyurethaneurea is prepared by reacting: (a) polyisocyanate and/or polyisothiocyanate-containing material comprising polyisocyanate, polyisothiocyanate, sulfur-containing polyisocyanate, sulfur-containing polyisothiocyanate or combinations thereof; (b) a first active hydrogen-containing material; and (c) a second active hydrogen-containing material different from (b).

3. The tinted article of claim 2, wherein the first active hydrogen-containing material (b) comprises: a hydroxyl group-containing compound; an amino-group-containing compound; and/or an SH group-containing compound.

4. The tinted article of claim 2, wherein the second active hydrogen containing material (c) comprises at least two active hydrogen-containing groups comprising OH groups, SH groups and/or amino groups.

5. The tinted article of claim 2 wherein said polyisocyanate-containing material comprises: aliphatic; cycloaliphatic; and/or aromatic polyisocyanates, cyclic dimers and cyclic trimers thereof and mixtures thereof.

6. The tinted article of claim 1 wherein said polyurethaneurea material is prepared by the reaction of polyurethane prepolymer with amine-containing curing agent.

7. The tinted article of claim 2 wherein said active hydrogen-containing material comprises polyol and/or polythiol.

8. The tinted article of claim 7 wherein said polyol comprises condensation polyester polyols, polycaprolactone polyols, polyether polyols, and/or polycarbonate polyols.

9. The tinted article of claim 2 wherein said active hydrogen-containing material (b) comprises polythiol comprising:
(a) thioether-functional, oligomeric polythiol having pendant hydroxyl functional groups, prepared by reacting together
1. at least one compound having at least two thiol functional groups;
2. at least one hydroxyl functional compound having triple bond functionality; and
3. optionally at least one compound having at least two double bonds
(b) a polythiol comprising an oligomer which is the reaction product of at least two different dienes and at least one dithiol; and wherein the stoichiometric ratio of the sum of the number of equivalents of dithiol to the sum of the number of equivalents of diene is greater than 1.0:1.0; or
(c) combinations thereof.

10. The tinted article of claim 6 wherein said polyurethane prepolymer is prepared by the reaction of polyisocyanate and/or polyisothiocyanate-containing material comprising polyisocyanate, polyisothiocyanate, sulfur-containing polyisocyanate, sulfur-containing polyisothiocyanate or combinations thereof with SH-containing material.

11. The tinted article of claim 10 wherein said SH-containing material comprises polythiol and/or materials having both hydroxyl and thiol functional groups.

12. The tinted article of claim 10 wherein said prepolymer has an (NCO+NCS):(SH+OH) equivalent ratio of from 2.0 to less than 5.5.

13. The tinted article of claim 11 wherein said polythiol comprises aliphatic polythiols, cycloaliphatic polythiols, aromatic polythiols, heterocyclic polythiols, and/or polymeric polythiols.

14. The tinted article of claim 6 wherein said amine-containing curing agent further comprises polythiol and/or polyol.

15. A method of preparing a tinted article which comprises a substrate having a refractive index of at least 1.57, said substrate comprising an at least partially polymerized sulfur-containing polyurethane and/or at least partially polymerized sulfur-containing polyurethaneurea material; said method comprising:
(a) applying an intermediate coating to at least a portion of at least one surface of said substrate;
(b) applying a tintable hardcoat to at least a portion of the intermediate coating; and
(c) applying a tint to at least a portion of the tintable hardcoat.

16. The method of claim 15 wherein the rate of tint uptake of the substrate having the intermediate coating applied thereto is less than the rate of tint uptake of the same substrate having no intermediate coating applied thereto.

17. The method of claim 15 wherein said said substrate comprising an at least partially polymerized sulfur-containing polyurethane and/or at least partially polymerized sulfur-containing polyurethaneurea material is prepared by reacting (a) polyisocyanate and/or polyisothiocyanate-containing material comprising polyisocyanate, polyisothiocyanate, sulfur-containing polyisocyanate, sulfur-containing polyisothiocyanates or combinations thereof; (b) a first active hydrogen-containing material; and (c) a second active hydrogen-containing material which is different from (b).

18. The method of claim 15 wherein said said substrate comprising an at least partially polymerized sulfur-containing polyurethane and/or at least partially polymerized sulfur-containing polyurethaneurea material is prepared by reacting polyisocyanate and/or polyisothiocyanate-containing material comprising polyisocyanate, polyisothiocyanate, sulfur-containing polyisocyanate, sulfur-containing polyisothiocyanates or combinations thereof with SH-containing material to form a polyurethane prepolymer; and reacting said polyurethane prepolymer with amine-containing curing agent.

19. The method of claim 18 wherein said SH-containing material comprises polythiol and/or materials having both hydroxyl and thiol functional groups.

20. The method of claim 18 wherein said polyisocyanate and/or polyisothiocyanate-containing material comprises: aliphatic; cycloaliphatic; and/or aromatic polyisocyanates and/or polyisothiocyanates.

21. The method of claim 18 wherein said prepolymer has a (NCO+NCS):(SH+OH) equivalent ratio of from 2.0 to less than 5.5.
